(19) United States
(12) Patent Application Publication
(10) Pub. No.: US 2025/0111363 A1
(43) Pub. Date: Apr. 3, 2025

(54) Auto-Substantiation Out-of-Pocket Accumulator

(71) Applicant: PayFlex Holdings, Inc., Omaha, NE (US)

(72) Inventors: Earl Lappen, Manchester, CT (US); Sunita Bijlani, Naperville, IL (US); Anil Kumar Boddu, Dallas, TX (US); Alison Burke, Layton, IL (US); Arunya Chelladurai, Aurora, IL (US); Jean Flom, Omaha, NE (US); Rekha Pawar, Scottsdale, AZ (US); Demmie Quinones, Chicago, IL (US); Robert Schragg, Omaha, NE (US); Scott Zier, Omaha, NE (US); Patricia SURPRENANT, Waterbury, CT (US); Jaylene TERMINELLO, Rindge, NH (US)

(73) Assignee: PayFlex Holdings, Inc., Omaha, NE (US)

(21) Appl. No.: 18/375,039

(22) Filed: Sep. 29, 2023

(51) Int. Cl. G06Q 20/40

(52) U.S. Cl. CPC G06Q 20/4014

(57) ABSTRACT

A transaction verification system is disclosed comprising one or more processors and one or more non-transitory computer-readable mediums having processor-executable instructions stored thereon. The processor-executable instructions, when executed by the one or more processors, facilitate receiving transaction data corresponding to a transaction between an account holder and a merchant, wherein the transaction data includes a transaction amount and identifying information for a payment account of the account holder. The instructions further determine whether the merchant associated with the transaction data has been previously verified and compare a spending limit associated with the payment account with the transaction amount. The instructions further update a record associated with the transaction data to indicate whether further verification is needed.

### BACKGROUND

Substantiation is a process by which an expense or transaction that is paid for using a tax-free healthcare account, such as a Flexible Spending Account (FSA) or a Health Reimbursement Arrangement (HRA), is verified. FSAs and HRAs are part of an employer's employee benefits program and are established with a pre-determined spending limit, based on the employee's election of pre-tax payroll contributions (FSA only) and the amount that the employer will contribute tax-free (FSA and HRA). See Treasury Regulations § 1.125 and IRS Publication 969 These accounts are generally administered by third-party administrators, commonly referred to as TPAs.

Employees who participate in their employer's FSA or HRA offering are referred to as accountholders, participants, and members; all three terms will be used interchangeably in this application. Accountholders access their healthcare account funds in primarily two (2) ways—by submitting a (paper or online) claim form with appropriate documentation or with the use of the debit card associated to the tax-free account.

When a member has a healthcare expense that includes an amount they are required to pay out of pocket, they can submit a claim via, for example, a completed and signed claim form. This claim can be for reimbursement to the member or a direct payment to the healthcare provider. When submitting the claim, the member may include the documentation that shows the expense to be eligible for reimbursement from the tax-free healthcare account. Allowable expenses for these accounts are generally governed by 213(d) of the Internal Revenue Code. In addition to 213 (d) expenses, tax-free healthcare accounts can also reimburse for over-the-counter (OTC) items and medications and menstrual care products. See Coronavirus Aid, Relief, and Economic Security Act, also known as the CARES Act, of 2020. While the tax-free healthcare account can be more restrictive than what is allowed (i.e., it doesn't reimburse or pay for all allowable 213 (d) expenses), it cannot cover expenses that are not otherwise allowed. Therefore, accountholders show documentation that the tax-free account funds were used for allowable expenses. Additionally, the expenses are for goods and services within the plan year of coverage, for a covered individual (i.e., the covered employee, their spouse and their tax dependents). The documentation submitted with the claim preferably identifies key elements of the expense-date the expense was incurred (also referred to as the date of service), patient or recipient name, provider or merchant name, expense type (medical, dental, vision, prescription, over-the-counter medicines and items, etc.), and the amount for which the member was responsible (i.e., the out-of-pocket amount). The primary document that will provide needed information to substantiate the expense as eligible is the Explanation of Benefits (EOB) from the healthcare insurance company that adjudicated the initial claim for the service rendered. If an EOB is not available (e.g., for an over-the-counter item), a detailed receipt or statement is generally acceptable.

A more preferred and common method of accessing funds in an FSA or HRA is with the use of a debit card attached to the pre-tax account. However, while the TPA records the debit card transaction and reduces the account balance by the amount of the transaction, the documentation does not come along with the card transaction. Debit card payments are verified that the payment was for an expense that is eligible for reimbursement from the account. See Treasury Regulations § 1.125-6 (d).

All card swipes first go through a Level 1 substantiation check. This generally occurs at the point of sale and is not part of any TPA's substantiation efforts. The point-of-sale substantiation is industry standard for healthcare cards and is governed by SIGIS (Special Interest Group for IIAS Standards). When a healthcare debit card is used at an Industry Information Approval System (IIAS) merchant-pharmacy, superstore, grocery store-eligible expenses (prescriptions, OTC items and medications, and menstrual products) are substantiated at the point of sale. The IIAS allows a retailer's point of sale system to identify eligible healthcare purchases by comparing Universal Product Code (UPC) or Stock Keeping Unit (SKU) numbers for purchased items against a pre-established list of eligible medical expenses. That substantiation status is passed along to the TPA. If the merchant is not IIAS certified, they use a Merchant Category Code (MCC) that allows for the use of a healthcare debit card; e.g., the healthcare debit card can be swiped at a retail location that contains a pharmacy (e.g., CVS, Walgreen's, Rite-Aid, etc.) but not at a gas station.

If the card transaction does not meet IIAS requirements, it becomes a “Level 2” substantiation. It is at this point that the administrator has the obligation to substantiate, using approved auto-substantiation methods including co-pay matches, recurring expenses (e.g., physical therapy, orthodontia), both of which are explicitly identified in Treasury Reg. § 1.125-6, and comparing a card payment to healthcare claims data for enhanced verification (EV). If the administrator is unable to substantiate the validity of the expense through these mechanisms, the administrator is obligated to contact the accountholder and request that the accountholder submit the documentation to verify the card expense.

When an accountholder receives a letter from the administrator (either via the U.S. Postal Service or, if the accountholder has electronic messages set up, via an email), the accountholder is given a number of options to resolve the unverified card purchase. As with manual claim submissions, a document to substantiate a card payment is the EOB from the insurance company. If there is no EOB, the accountholder can submit a detailed statement. If the accountholder has no documentation for the expense tied to the card payment, they can either pay back the account or submit an EOB or detailed statement for a different out-of-pocket expense from the same plan year. This option to use a different expense, that has not already been reimbursed to the accountholder or paid to the provider on behalf of the accountholder, is a process known as offsetting. It is important to note that offsetting does not require the same expense type. For example, a dental expense that cannot be substantiated can be offset by a vision or mental healthcare expense. Under current regulations, the key factor is that the expense is for the cost of “diagnosis, cure, mitigation, treatment, or prevention of disease, and for the purpose of affecting any part or function of the body”, including “for legal medical services rendered by physicians, surgeons, dentists, and other medical practitioners.” This also includes “the costs of equipment, supplies, and diagnostic devices needed for these purposes. They don't include expenses that are merely beneficial to general health, such as vitamins or a vacation.” See IRS Publication 502.

If the accountholder does not submit the required documentation, does not offset the expense with another (allowable and unreimbursed) expense, and does not pay back the account for the unverified amount, the administrator is obligated to deactivate the debit card associated with the account until verification is received. This process imposes significant hardships on the accountholder, who is only seeking to use their funds to pay for needed medical care. The accountholder may no longer have copies of the EOB or detailed statement. The accountholder may struggle with gathering and submitting the documentation. The accountholder may be unaware that the card has been deactivated until they attempt to use it, putting them in the awkward position of having a card that doesn't work and having to make the decision to either forgo the needed healthcare expense or pay out of pocket when they didn't plan to do so and submit a claim for reimbursement.

Accordingly, there is a need for a system that the TPA can leverage to further review healthcare claims data to reduce card cancellations, create a more efficient process to perform auto-substantiation, and take the burden off the accountholders.

### BRIEF DESCRIPTION OF THE DRAWINGS

The present invention will be described in even greater detail below. The features and advantages of various embodiments of the present invention will become apparent by reading the following detailed description with reference to the attached drawings which illustrate the following:

FIG. 1 is a simplified process flow showing the high-level interaction of one embodiment of the invention within the TPA's existing environment.

FIG. 2 is one embodiment of a swim lane depiction of the substantiation process.

FIG. 3 is a swim lane depiction of the substantiation process with on embodiment of the invention.

FIG. 4 is a simplified illustration depicting an environment in which exemplary embodiments of the present application are applicable.

FIG. 5 is a flowchart illustrating an embodiment of an inventive process for determining whether to verify a transaction.

### DETAILED DESCRIPTIONS

In one embodiment of the disclosed invention, the invention leverages stored claims data to determine the total out-of-pocket obligation for each member across expense types (medical, dental, vision, mental health, etc.) for the current plan year. Out-of-pocket obligations may include deductibles, co-pays, co-insurance, and out-of-network costs. This cumulative total by member is then compared to the member's pre-determined spending limit on the tax-free healthcare account. When a member's cumulative out-of-pocket total is equal to or greater than the member's pre-determined spending limit for the plan year, substantiation becomes moot. With the ability to offset any card purchases with other allowable expenses, a total out-of-pocket obligation that is at least as much as the pre-determined spending limit for the tax-free healthcare account satisfies the regulatory verification requirement.

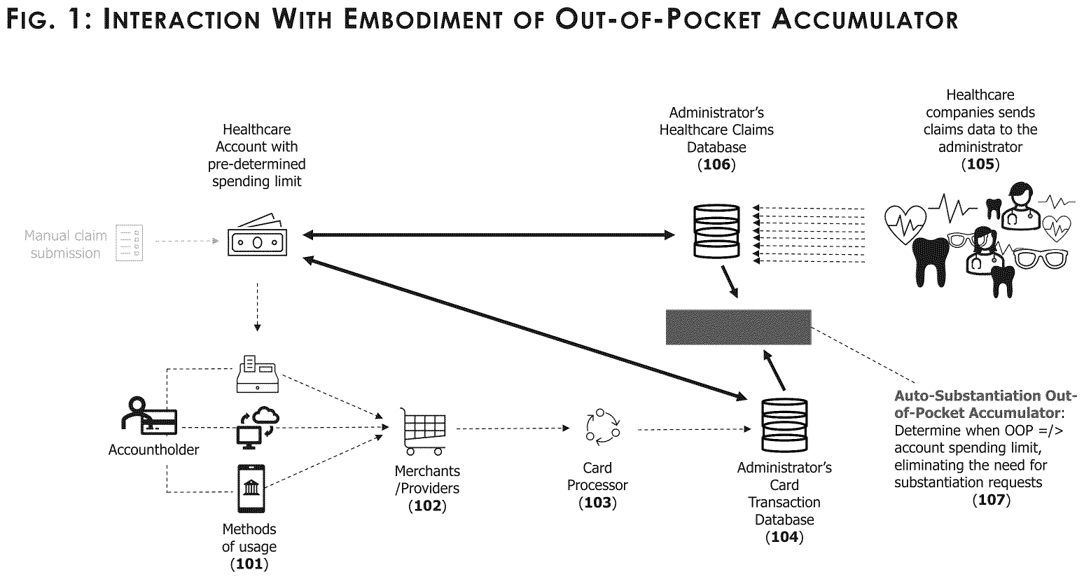

As depicted in FIG. 1, in one embodiment the invention includes the use of a plurality of methods 101 for the cardholder to interact with merchants and healthcare providers 102. The methods for interacting with merchants may include in-person at the point of service, online purchases and payments, and use of a debit card wallet.

Merchants and healthcare providers 102 may use point-of-sale (POS) machines, servers, or other devices to process transactions. These transactions go through the card processor 103 for transactional and settlement purposes. Note, this is standard processing for debit and credit cards; a card processor is not unique to the cards aligned with tax-free healthcare accounts. These include card swipes, personal identification number (PIN) verifications, and touchless transactions (e.g., Apply Pay® or Google Pay®).

In the illustrated embodiment, the transactions are passed along from the card processor 103 to the administrator, where transactions are stored in their card transaction database 104. The stored card transactions are recorded in the accountholder's account and used to calculate the remaining balance available from the pre-determined spending limit. A card processor 103 may use application programming interface (API) or an industry standard such as International Standards Organization (ISO) 8583 messaging to securely transmit card transactions.

In addition to card transactional activity, the TPA may intake and store claims from multiple and numerous healthcare insurance carriers 105 (e.g., Aetna, Blue Cross/Blue Shield, Cigna, Delta Dental, EyeMed, UnitedHealth, etc.) on behalf of various and numerous plan sponsors. The TPA systematically may receive claim files daily, weekly, bi-weekly, and monthly, depending on the cadence established with each carrier and employer/plan sponsor. Note, data may be exchanged via electronic files uploaded via secure file transfer protocol (SFTP). The use of SFTP for the purposes of data exchange is a standard industry practice. The TPA uploads and processes these files systematically. Claims data is stored in a Healthcare Claims Database 106.

Historically, the TPA has leveraged the stored claims data to support the Enhanced Verification (EV) process. EV automatically matches debit card transactions to stored healthcare claims, based on matches to plan year, expense type, provider, date of service, and amount that member was responsible to pay for the care. When the system detects a match, it marks the claim so it cannot be used for another card transaction (i.e., no “double-dipping”).

In one embodiment of the current invention, the TPA further leverages this claims data, specifically the out-of-pocket amounts that are passed and stored in the Claims Database 106. As previously stated, in one embodiment the invention accesses the stored claims data to determine the total out-of-pocket obligation for each member across expense types allowed for the account (medical, dental, vision, mental health, etc.) for the current plan year. Out-of-pocket obligations include deductibles, co-pays, co-insurance, and out-of-network costs. This cumulative total by member is then compared to the member's pre-determined spending limit on their tax-free healthcare account. When a member's cumulative out-of-pocket total is equal to or greater than that member's pre-determined spending limit for the plan year, that member's account is deemed “Accumulator Verified”. A healthcare spending account with a status of “Accumulator Verified” will not require any substantiation efforts for the remainder of the plan year. This also includes any verification requests that are in motion. The systematically-established “Accumulator Verified” status will re-activate a card that may have been inactivated for lack of substantiation, stop any member request letters in queue, and mark any unverified card transactions as verified/substantiated.

It will be appreciated that the amount of transaction data being stored and processed constitutes an amount for which it would be impracticable or impossible for a person or persons to manually analyze. For example, the amount of transaction data being stored and processed is on the order of hundreds of millions of transactions, and involves correspondingly large datasets; i.e., on the order of terabytes (TBs). In an exemplary implementation, the transaction databases 104 and 106 are implemented as Relational Database Management Systems (RDBMS).

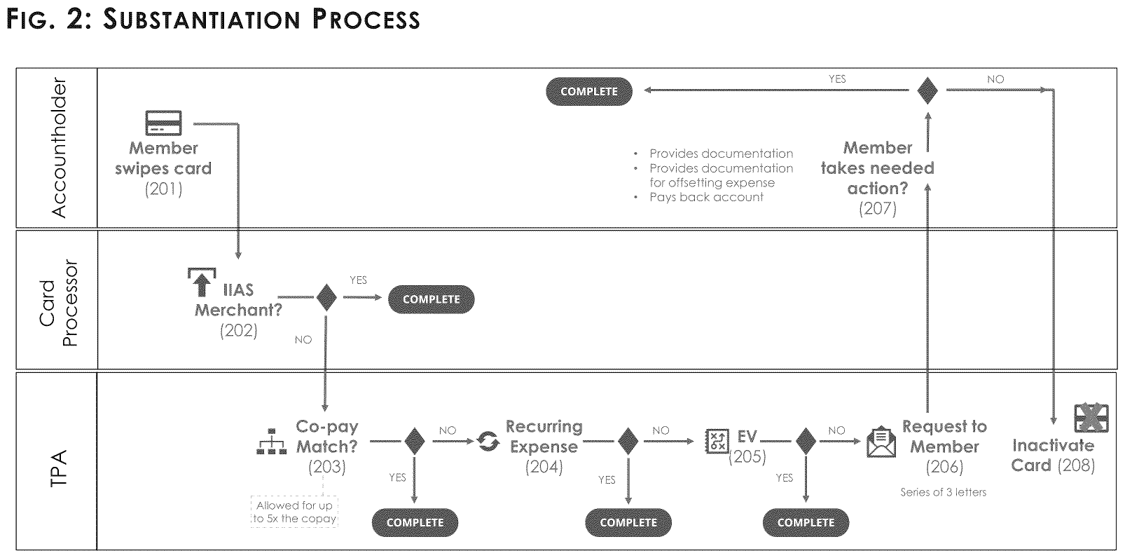

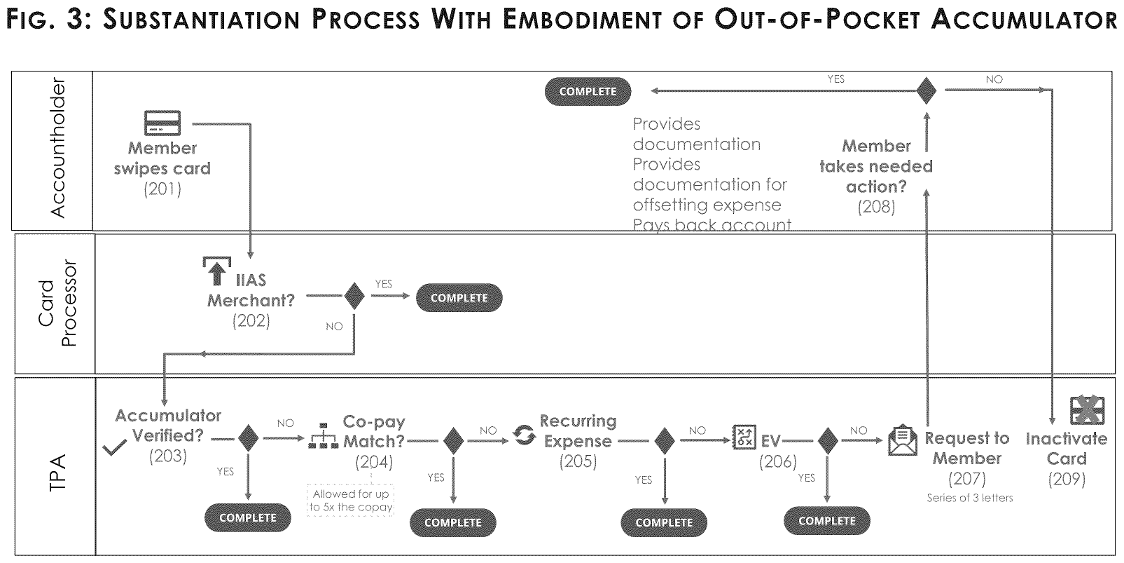

Describing FIG. 2 and FIG. 3 will explain embodiments of how the “Accumulator Verified” status may be applied to member accounts and within the substantiation workflow.

FIG. 2 is a swim lane depiction of the end-to-end substantiation process for a card transaction. The process starts with the member using their healthcare account debit card 201 to pay for their out-of-pocket cost for healthcare or for the purchase of healthcare-related or menstrual items. Note, this flow is based on the member having funds available in the pre-tax account. If there are no funds remaining (i.e., the member has spent the totality of their pre-determined spending limit), the card will be declined at the point of payment.

The card processor will determine if the purchase is IIAS approved 202. If so, that status will be passed to the TPA, and the substantiation process is complete. If the card was not used at an IIAS-approved merchant, the TPA has the obligation to substantiate the expense.

As a first step in substantiation, the TPA systematically compared the card transaction amount to the values stored on a copay table 203, to determine if the amount paid was for one or more copays associated with the healthcare plan coverage. (Prior to the beginning of the plan year, the employer provides the copay amounts to the TPA, which builds out tables up to multiples of five.) If the card transaction is equal to one or more (up to five) copays, the substantiation process is complete.

If there is no copay match, the TPA then determines if the card transaction matches to a recurring expense 204. If the card transaction was for a recurring expense, the substantiation process is complete.

If the card payment was not for a recurring expense, the TPA will then revert to its Enhanced Verification (EV) process 205. This process compares the information from the card swipe to detailed claims data to find a match. If the TPA is able to match the card transaction to a specific claim, the substantiation process is complete. The claim is also flagged within the Healthcare Claims Database (FIG. 1, 106) to ensure the claim is not used for another card transaction (i.e., no “double-dipping”).

If the card payment cannot be matched to a specific claim, the TPA has no other option but to contact the accountholder 206 for the needed information. As previously stated, this poses a hardship on the accountholder who may not fully understand the substantiation process or may not be able to locate the documentation. If the member does provide the detailed information required to substantiate the card transaction 207, the process is complete.

If the member fails to provide the information after numerous attempts from the TPA 206, the TPA will inactivate the debit card 208. This card inactivation status imposes an even greater hardship on the accountholder. The accountholder may attempt to use the card without realizing its inactive status, and the card will be declined at the point of sale. In addition to the awkwardness of having the card declined, the accountholder will be faced with what could be a difficult decision: defer the purchase or pay out of pocket if they have another method of payment (e.g., cash, personal credit card, personal debit card, etc.). In addition to having an unexpected expense to pay, the cardholder will have to submit a claim, including the documentation to support the claim, in order to receive a reimbursement of the out-of-pocket expense.

All of this drives calls from accountholders, who call the TPA to get clarity on the process they do not understand, to seek assistance and guidance in resolving an unverified claim in order to reactivate their card, and to complain about the process that is frustrating and time-consuming for them. In response to this poor accountholder experience, embodiments of the present invention were implemented to decrease the amount of wasted human effort on both the accountholder and TPA side and to increase the auto-substantiation rates that reduce the need for human intervention.

FIG. 3 is a swim lane depiction of the end-to-end substantiation process for a card transaction according to the teachings of one embodiment of the disclosed invention. With the deployment of the embodiment, the TPA's substantiation process starts at the member's tax-free account. If the account status is Accumulator Verified 203, the substantiation process need go no further. The TPA's proprietary system will have determined that the cumulative total of the member's out-of-pocket healthcare costs for the plan year justifies the substantiation or offset of card payments for that same plan year.

If the member's account is not verified for the Out-of-Pocket Accumulator (i.e., the member's out-of-pocket costs have not reached the threshold of the account's pre-determined spending limit), the TPA will then take up the transaction and first compare it to the copay table. The remaining processes here are the same as those described in FIG. 2, with a shift in the numerical references; e.g., Co-pay Match 203 in FIG. 2 is now Co-pay Match 204 in FIG. 3. This is illustrative of how those steps now come after the account verification in accordance with one embodiment of the invention.

### VARIOUS EMBODIMENTS

Example #1: Member has a Flexible Spending Account (FSA) with a $2,700 predetermined limit (i.e., annual election amount). This illustrative example shows member using their card to access the healthcare account funds.

| | | | FSA | TRANSACTION |
|---|---|---|---|---|
| Ex. | | TRANSACTION | RUNNING | STATUS/ |
| #1 | ACTIVITY | AMOUNT | BALANCE | ACCOUONT STATUS NOTES |
| 1 | Day 1 of new Plan Year | | $2,700 | Pre-determined limit; aka annual election amount |
| 2 | Member uses card for $300 | ($300) | $2,400 | Transaction is IIAS certified |
| 3 | Member uses card for $125 | ($125) | $2,275 | TPA auto-substantiates expense |
| 4 | Out-of-Pocket Total at $1,000 | | | Invention continues to track out-of-pocket amounts |
| 5 | Member uses card for $25 | ($25) | $2,250 | TPA cannot substantiate |
| 6 | Member uses card for $400 | ($400) | $1,850 | TPA auto-substantiates expense |
| 7 | Out-of-Pocket Total at $2,800 | | | Healthcare account set at “Accumulator Verified” |
| 8 | Member uses card for $75 | ($75) | $1,775 | Amount not subject to substantiation |

Line item 1: Pre-determined limit is set at $2,700.
Line item 2: Member begins using debit card. In this example, the first time that the member uses the card is at an IIAS merchant. Card processor confirms this and TPA records it. Healthcare account balance is reduced by the amount of this transaction. No further action required.
Line item 3: Member uses the card for an expense that the TPA can auto-substantiate with a co-pay table match, as a recurring expense, or through Enhanced Verification using stored claims data. Healthcare account balance is reduced by the amount of this transaction. No further action required.
Line item 4: Out-of-Pocket Accumulator tracks to total out-of-pocket to date for the plan year. Note, this one line is illustrative to show how the out-of-pockets amounts add up while member is using funds from the healthcare account. A fully detailed example would present a separate line item each time the out-of-pocket accumulator totals to a new cumulative amount.
Line item 5: Member uses the card for an expense that the TPA cannot auto-substantiate. Healthcare account balance is reduced by the amount of this transaction. TPA sends request to member for detailed documentation.
Line item 6: Member uses the card for an expense that the TPA can auto-substantiate with a co-pay table match, as a recurring expense, or through Enhanced Verification using stored claims data. Healthcare account balance is reduced by the amount of this transaction. No further action required. No response yet from member on unverified transaction from line 4.
Line item 7: Out-of-Pocket Accumulator shows the out-of-pocket total for the plan year ($2,800) to be greater than the pre-determined limit ($2,700) for the plan year. At this point, the healthcare account reflects a substantiation status of “Accumulator Verified”. The transaction for $25 (line item 5) re-sets to substantiated. The next letter in queue for this transaction is cancelled. The member's online account no longer shows that there is an expense that should be substantiated.
Line item 8: Member uses the card for an expense. With the “Accumulator Verified” status, no further action is required. Healthcare account balance is reduced by the amount of this transaction. For any additional card transactions from this point through the end of the plan year, no further action will be required.

Example #2: Member has a Flexible Spending Account (FSA) with a $2,000 predetermined limit (i.e., annual election amount). This illustrative example shows member was faced with a deactivated card and had to submit a claim for reimbursement.

| | | | FSA | TRANSACTION |
|---|---|---|---|---|
| Ex. | | TRANSACTION | RUNNING | STATUS/ACCOUONT |
| #2 | ACTIVITY | AMOUNT | BALANCE | STATUS NOTES |
| 1 | Day 1 of new Plan Year | | $2,000 | Pre-determined limit; aka annual election amount |
| 2 | Member uses card for $5 | ($5) | $1,995 | TPA cannot substantiate |
| 3 | Out-of-Pocket Total at $500 | | | Invention continues to track out-of-pocket amounts |
| 4 | Member uses card for $25 | ($25) | $1,970 | TPA auto-substantiates expense |
| 5 | Out-of-Pocket Total at $1,600 | | | Invention continues to track out-of-pocket amounts |
| 6 | Card is deactivated | | | Member has not resolved the $5 expense (line item 2) |
| 7 | Member tries to card for $75 | $0 | $1,970 | Card rejected at point of sale; member pays out of pocket |
| 8 | Member submits claim for $75 | ($75) | $1,895 | Claim fully processed for reimbursement to member |
| 9 | Out-of-Pocket Total at $2,050 | | | Healthcare account set at “Accumulator Verified” |
| 10 | Member uses card for $50 | ($50) | $1,845 | Amount not subject to substantiation |

Line item 1: Pre-determined limit is set at $2,000.
Line item 2: Member begins using debit card, for $5. The TPA cannot auto-substantiate this expense. Healthcare account balance is reduced by the amount of this transaction. TPA sends request to member for detailed documentation.
Line item 3: Out-of-Pocket Accumulator is tracking to total out-of-pocket to date for the plan year. Note, this one line is illustrative to show how the out-of-pockets amounts add up while member may or may not be using funds from the healthcare account. A fully detailed example would present a separate line item each time the out-of-pocket accumulator totals to a new cumulative amount.
Line item 4: Member uses the card for an expense that the TPA can auto-substantiate with a co-pay table match, as a recurring expense, or through Enhanced Verification using stored claims data. Healthcare account balance is reduced by the amount of this transaction. No further action required.
Line item 5: Out-of-Pocket Accumulator continues to track to total out-of-pocket to date for the plan year.
Line item 6: TPA has suspended the card. This is due to the card transaction for $5, which has not been substantiated after numerous requests from the TPA. Note, many accountholders find it confusing and frustrating to have to substantiate small dollar amounts. However, TPAs are required to substantiate card transactions regardless of the amount. See Proposed Treasury Regulations 1.125-6 (b).
Line item 7: Member attempts to use the card; however, it is declined at the point of service. Many times, members do not understand that their card will be suspended if an unverified expense is not resolved. In this example, the member paid out of pocket and will submit a claim for reimbursement. There is no change in the healthcare account balance.
Line item 8: Member submits the claim for reimbursement. In doing this, the member logged into the member website to complete an online claim form. The member also would have to upload the documentation to show that the expense is eligible for reimbursement from a healthcare account.
Line item 9: Out-of-Pocket Accumulator shows the out-of-pocket total for the plan year ($2,050) to be greater than the pre-determined limit ($2,000) for the plan year. At this point, the healthcare account reflects a substantiation status of “Accumulator Verified”. The card is reactivated and ready for use. The transaction for $5 (line item 2) re-sets to substantiated. The member's online account no longer shows that there is an expense that needs substantiation.
Line item 10: Member uses the card for an expense. With the “Accumulator Verified” status, no further action is required. Healthcare account balance is reduced by the amount of this transaction. For any additional card transactions from this point through the end of the plan year, no further action will be required.

Example #3: Member has a Health Reimbursement Arrangement (HRA) with an initial pre-determined limit of $1,500. Unlike FSAs, there is no limit to how much an employer can contribute to HRAs. The plan sponsor can structure the plan so that it requires action from the member to earn more funds into the account.

| | | | HRA | TRANSACTION |
|---|---|---|---|---|
| Ex. | | TRANSACTION | RUNNING | STATUS/ |
| #3 | ACTIVITY | AMOUNT | BALANCE | TPA ACTION/NOTES |
| 1 | Day 1 of new Plan Year | | $1,500 | Pre-determined limit |
| 2 | Member uses card for $35 | ($5) | $1,495 | TPA auto-substantiates expense |
| 3 | Member uses card for $25 | ($25) | $1,470 | TPA cannot substantiate |
| 4 | Member uses card for $35 | ($35) | $1,435 | TPA auto-substantiates expense (recurring expense) |
| 5 | Member completes health assessment | $75 | $1,510 | Pre-determined limit is recalculated to $1,575 |
| 6 | Out-of-Pocket Total at $600 | | | Invention continues to track out-of-pocket amounts |
| 7 | Member uses card for $80 | ($80) | $1,430 | TPA cannot substantiate |
| 8 | Out-of-Pocket Total at $1,600 | | | Invention continues to track out-of-pocket amounts |
| 9 | Member uses card for $50 | ($50) | $1,380 | Amount not subject to substantiation |

Line item 1: Pre-determined limit is set at $1,500.
Line item 2: Member uses debit card and the TPA can auto-substantiate the expense. The Healthcare account balance is reduced by the amount of this transaction. No further action required.
Line item 3: Member uses the card for an expense that the TPA cannot auto-substantiate. Healthcare account balance is reduced by the amount of this transaction. TPA sends request to member for detailed documentation.
Line item 4: Member uses debit card and the TPA can auto-substantiate the expense. The Healthcare account balance is reduced by the amount of this transaction. No further action required.
Line item 5: Member completes a Health Risk Assessment, one type of incentive that the plan offers to increase the available funds in the account. Healthcare account balance and pre-determined limit are increased by the amount of this incentive.
Line item 6: Out-of-Pocket Accumulator tracks to total out-of-pocket to date for the plan year. Note, this one line is illustrative to show how the out-of-pockets amounts add up while member is using funds from the healthcare account. A fully detailed example would present a separate line item each time the out-of-pocket accumulator totals to a new cumulative amount.
Line item 7: Member uses the card for an expense that the TPA cannot auto-substantiate. Healthcare account balance is reduced by the amount of this transaction. TPA sends request to member for detailed documentation.
Line item 8: Out-of-Pocket Accumulator shows the out-of-pocket total for the plan year ($1,600) to be greater than the pre-determined limit ($1,575) for the plan year. At this point, the healthcare account reflects a substantiation status of “Accumulator Verified”. The transactions for $25 and $80 (line items 3 and 7, respectively) re-set to substantiated. The next letter in queue for these transactions is cancelled. The member's online account no longer shows that there is an expense that should be substantiated.
Line item 9: Member uses the card for an expense. With the “Accumulator Verified” status, no further action is required. Healthcare account balance is reduced by the amount of this transaction.

Example #4: This is another example with a Health Reimbursement Arrangement (HRA), intended to show the complexity of this account type in relation to the invention.

| | | | HRA | TRANSACTION |
|---|---|---|---|---|
| Ex. | | TRANSACTION | RUNNING | STATUS/TPA |
| #4 | ACTIVITY | AMOUNT | BALANCE | ACTION/NOTES |
| 1 | Day 1 of new Plan Year | | $1,000 | Initial pre-determined limit |
| 2 | Member submits claim for $800 | ($800) | $200 | Claim fully processed for reimbursement to member |
| 3 | Member uses card for $25 | ($25) | $175 | TPA cannot substantiate |
| 4 | Out-of-Pocket Total at $1,100 | | | Healthcare account set at “Accumulator Verified” |
| 5 | Member completes health assessment | $75 | $250 | Pre-determined limit is recalculated to $1,075 |
| 6 | Member uses card for $80 | ($80) | $170 | Amount not subject to substantiation |
| 7 | Member completes two (2) | $150 | $320 | Pre-determined limit is recalculated to $1,225; |
| | incentive program | | | “Accumulator Verified” status removed from account |
| 8 | Member uses card for $50 | ($50) | $270 | TPA cannot substantiate |
| 9 | Out-of-Pocket Total at $1,500 | | | Healthcare account set at “Accumulator Verified” |

Line item 1: HRA set with pre-determined limit of $1,000.
Line item 2: Member submits claim, that is fully adjudicated. Member receives reimbursement. The Healthcare account balance is reduced by the amount of the claim. No further action required.
Line item 3: Member uses the card for an expense that the TPA cannot auto-substantiate. Healthcare account balance is reduced by the amount of this transaction. TPA sends request to member for detailed documentation.
Line item 4: Out-of-Pocket Accumulator shows the out-of-pocket total for the plan year ($1,100) to be greater than the pre-determined limit ($1,000) for the plan year. At this point, the healthcare account reflects a substantiation status of “Accumulator Verified”. The transaction for $25 (line items 3) is set to substantiated. The next letter in queue for this transaction is cancelled. The member's online account no longer shows that there is an expense that should be substantiated.
Line item 5: Member completes a Health Risk Assessment, one type of incentive that the plan offers to increase the available funds in the account. Healthcare account balance and pre-determined limit are increased by the amount of this incentive. There is no impact to the accumulator verification status, as the new pre-determined limit ($1,075) is less than the accumulated out-of-pocket costs ($1,100) for this member.
Line item 6: Member uses the card for an expense. With the “Accumulator Verified” status, no further action is required. Healthcare account balance is reduced by the amount of this transaction.
Line item 7: Member completes two (2) additional incentives for additional funding into the HRA. Healthcare account balance and pre-determined limit are increased by the amount of this incentive. The new pre-determined limit ($1,225) is greater than the accumulated out-of-pocket costs ($1,100) for this member. The “Accumulator Verified” status is removed from the account. The TPA again reaches out to the member for the $25 transaction from line 3 requesting documentation. TPA's system also picks up the $80 transaction from line 6 and runs it through the auto-substation review (as depicted in FIG. 3). If the TPA can auto-substantiate the process will be complete for that transaction. If the TPA cannot auto-substantiate the $80 transaction, it will send a request to the member for detailed documentation.
Line item 8: Member uses the card for an expense that the TPA cannot auto-substantiate. Healthcare account balance is reduced by the amount of this transaction. TPA sends request to member for detailed documentation.
Line item 9: Out-of-Pocket Accumulator shows the out-of-pocket total for the plan year ($1,500) to be greater than the pre-determined limit ($1,225) for the plan year. The healthcare account once again reflects a substantiation status of “Accumulator Verified”. The transactions pending member substantiation will be systematically substantiated. The next letter(s) in queue for these transactions is cancelled. The member's online account no longer shows that there are expenses that should be substantiated.

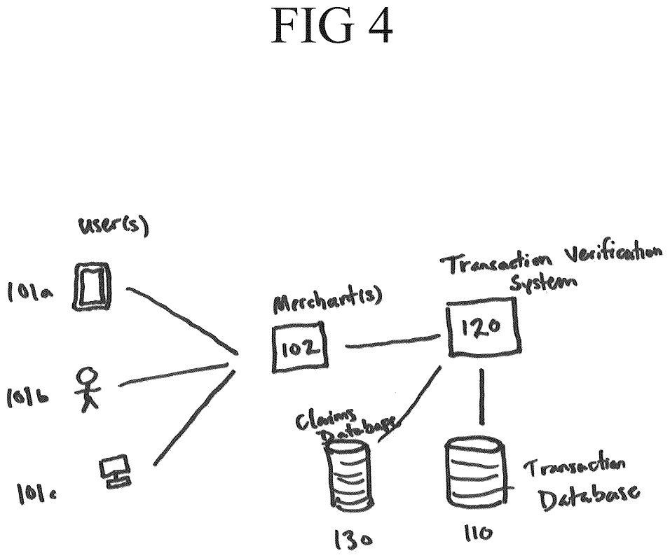

FIG. 4 is a simplified illustration depicting an exemplary environment in which exemplary embodiments of the present application are applicable. As shown in FIG. 4, example implementation 400 may include one or more computing devices. In some implementations, the one or more computer devices may be on a local network. In some implementations, the one or more computing devices may communicate via the local network. In some implementations, the multiple computing devices may communicate via the local network and/or a device, such as a modem, router, and/or the like, associated with the local network via a network, such as the internet. In some implementations, the multiple computing devices may communicate via the network (e.g., without communicating via the local network).

The exemplary environment includes a plurality of users 401 interacting with one or more merchants 402. The plurality of users 401 interacting with the one or more merchants 402 may include, for example, in-person or online credit card transactions, debit card transactions, HRA card transactions, and/or FSA card transactions, as well as other types of transactions. Transaction data corresponding to transactions conducted between the plurality of users 401 and the one or more merchants is transmitted to and stored in a transaction database 410. The transaction data may include transaction data for successfully completed transactions.

The one or more merchants 402 may include entities such as businesses or persons which use devices such as point-of-sale (POS) machines, servers or other devices to process transactions. The term “merchant” as used herein may refer to any entity or device where user information is used to carry out a transaction.

The transaction database may be connected with a transaction verification system 420. In FIG. 4, the transaction database 410 of FIG. 4 is separate from and in communication (e.g., over a communication network via a wired or wireless connection) with a transaction verification system 420. In some embodiments, the transaction verification system 420 may be integrated with the transaction database. The transaction verification system 420 may comprise one or more computing devices. The transaction verification system 420 may obtain or receive transaction data from the transaction database and determine whether it is necessary to perform a verification of the transaction data.

For example, in the case of HRA or FSA cards associated with a healthcare entity, the healthcare entity may work with a transaction processing vendor to manage the HRA or FSA cards and the accounts and transactions associated therewith. Thus, the transaction processing vendor may obtain and store transaction data corresponding to HRA or FSA cards in transaction database 410, and the healthcare entity may operate the transaction verification system 420 which is in communication with and uses the transaction data from the transaction database 410. In other embodiments, transaction verification system 420 may be managed on behalf of an insurer or underwriter. In other embodiments, transaction verification system 420 may be managed by an employer that provides accounts to its employees for healthcare-related expenses (such as an FSA or HRA). In some embodiments, transaction verification system 420 may be part of a larger system that manages payments made to the one or more merchants 402.

It will be appreciated that the exemplary environment depicted in FIG. 4 is merely an example, and that the principles discussed herein may also be applicable to other situations—for example, including other types of merchants, other types of payment information, etc.

It will be appreciated that the amount of transaction data being stored and processed constitutes an amount for which it would be impracticable or impossible for a person to manually analyze. For example, the amount of transaction data being stored and processed may be on the order of thousands of transactions or more, and may involve correspondingly large datasets (e.g., on the order of MBs or GBs or more). In an exemplary implementation, the transaction database 410 may be implemented as, for example, a structured query language (SQL) server. The transaction database 410 cooperates with a big data analytics engine 430 (for example, which may comprise a plurality of computing nodes and which may utilize Apache Spark) and a big data warehouse 440 (for example, which may comprise a plurality of distributed storage nodes and which may utilize Apache Hadoop and/or Hive) for ingestion of the data into the transaction verification system, processing of the data to prioritize transactions for verification, and outputting of the results.

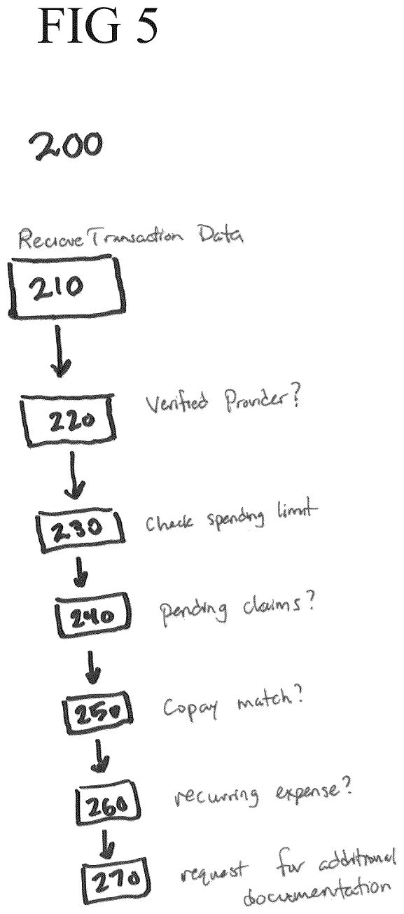

FIG. 5 is a flow chart of an example process 500 for verifying a transaction via a verification system. In some implementations, one or more process blocks of FIG. 4 may be performed by a transaction verification system (e.g., transaction verification system 420). In some implementations, one or more process blocks of FIG. 5 may be performed by another device or a group of devices separate from or including the transaction verification system.

As shown in FIG. 5, process 500 may include receiving transaction data (block 510). The transaction data may be associated with a payment for goods or services using a payment account. The payment account may be associated with healthcare expenses, such as a Healthcare Savings Account (HSA), a Health Reimbursement Arrangement (HRA), or a Flexible Spending Account (FSA). The transaction data may be sent from a point of sale (POS) location. The transaction data may be sent by another server associated with the payor or payee. The transaction data may be retrieved from a transaction database (such as transaction database 410).

The transaction data for each respective transaction may include a plurality of data elements. For example, in an exemplary implementation, the transaction data for a respective transaction may include the following parameters: the name of the person who is the account holder, a user ID, a username, a transaction amount, category code (e.g., a Merchant Category Code (MCC)), country code, merchant location, merchant ID, merchant name, and/or a transaction timestamp. The transaction data may include identification information associated with the payment account (such as an account number). The transaction data may include information identifying the good(s) or service(s) that were purchased in the transaction.

In some embodiments, the transaction data may be part of a claim for reimbursement of the transaction from the payment account. The transaction data may be in the form of one or more receipts.

Next, process 500 may include determining whether the merchant is a verified provider (block 520). This may include retrieving information from a database of previously-verified merchants. The database may be part of an Inventory Information Approval System (IIAS). The previously-verified merchants may be providers who have been previously approved (or previously substantiated). The merchant information in the transaction data (such as information identifying the party providing the goods or services) may be compared with information in the database of previously-verified merchants. This may be done by comparing the goods and/or services associated with the transaction with information from a database. The database may be part of an IIAS. If there is a match, the process 500 may end. Step 520 may also include verifying whether the transaction is previously verified.

Next, process 500 may include comparing the transaction amount with a spending limit associated with the payment account (block 530). Transaction verification system may retrieve a total authorized spending amount for the payment account in the current calendar year. The total authorized spending amount may be the total amount of spending that has already been authorized for the payment account in the current calendar year. The transaction verification system may add the transaction amount from the transaction data to the total authorized spending amount to compute a pending total. The transaction verification system may compare this pending total with a spending limit associated with the payment account. The spending limit may be an authorized election associated with the payment account.

If the pending total exceeds the spending limit, verification system may determine that no further verification is needed, and process 500 may end. The verification system may update a record associated with the transaction to indicate that no further verification is needed.

In one example, an individual may purchase a leg brace for $500 from a merchant. The individual may submit a $500 claim for reimbursement from his FSA account. In this example, the individual has yearly election of $5000 that can reimbursed by the account each year. If the verification system determines that the account has already reimbursed $4700 in charges for the year, the verification system will not need to verify the $500 claim, because it is unnecessary to do so since it would otherwise cause the account to exceed its yearly limit for reimbursements.

Next, process 500 may include determining whether the account holder associated with the transaction data has other claims pending for the same payment account (block 540). Transaction verification system 420 may retrieve claim information associated with the payment account from a claims database 430. The claims database may store pending claims for reimbursement associated with the same payment account associated with the transaction data. The pending claims may include a transaction amount for each pending claim. Transaction verification system may retrieve the total authorized spending amount for the current calendar year and add the transaction amount from each pending claim to compute a pending claims total. Transaction verification system may compare the pending claims total to a spending limit associated with the payment account. If the pending claims total exceeds the spending limit, verification system may determine that no further verification is needed, and process 500 may end.

In one example, an individual may purchase a leg brace for $500 from a merchant. The individual may submit a $500 claim for reimbursement from his FSA account. In this example, the individual has yearly election of $5000 that can reimbursed by the account each year. If the verification system determines that the account has already reimbursed $4000 in charges for the year, and that there are other pending claims that total $1000, the verification system will not need to verify the $500 claim, because it is unnecessary to do so since it would otherwise cause the account to exceed its yearly limit for reimbursements given the pending claims that have already been approved or processed.

Next, process 500 may include determining whether a copay match exists (block 550). This may include retrieving insurance information for the account holder (such as from the account holder's employer). The insurance information may include a copay amount. Transaction verification system 420 may compare the transaction amount from the transaction data with the copay amount. If the copay amount matches the transaction amount (or is within a certain multiple of the transaction amount), the transaction verification system may determine whether the account holder and/or the account holder's employer provides a benefit associated with the transaction. In some embodiments, if the transaction amount is within a predetermined threshold of the copay amount (e.g., $50), the transaction verification system may determine whether the account holder's employer provide the benefit associated with the transaction. If the transaction verification system determines it does, the transaction may be verified, and the process 500 may end. If the copay amount does not match the transaction amount (or is not within a predetermined threshold of the payment amount), the process may proceed to block 560.

Next, process 500 may include determining whether the transaction associated with the transaction data is a recurring expense (block 570). Transaction verification system 420 may compare the transaction amount with previously approved transaction amounts for the same account holder. If the transaction amount exactly matches a previously approved transaction amount, the transaction may be verified and process 500 may end. In some embodiments, if the transaction amount is within a predetermined threshold of a previously approved transaction amount (e.g., $50), the transaction may be verified and process 500 may end. In some embodiments, information from the transaction data associated with the merchant or provider of the good or service may also be compared with a database of previously-approved merchants. If there is a match, the transaction may be verified, and process 500 may end.

Next, process 500 may include initiating requests to the account holder for additional documentation to support verification (block 580). The request may be in the form of an electronic notification. The request may be in the form of a letter.

In some embodiments, transaction verification system 420 may analyze spending patterns of the account holder as part of the verification process. For example, transaction verification system 420 may retrieve a payment history for the payment account to determine whether the account has a history of recurring payments that have been previously verified. For example, the account may have a history of recurring monthly payments of $100 for a prescription to a verified provider. Transaction verification system may use this information to assume that the payment account will be charged $100 per month going forward for the remainder of the calendar year for the same prescription. For example, if it is June, verification system 420 may assume that the payment account will be charged $100/month for the remaining 6 months of the year, meaning there will be $600 of additional charges for the calendar year. Transaction verification system may add the $600 to the current total authorized spending amount on the account and compare that total to the authorized spending limit on the account for that calendar year. If the calculated amount exceeds the total authorized spending limit, transaction verification system 420 may determine that it does not need to perform further verification of a pending transaction that is unverified.

In some embodiments, transaction verification system 420 may prioritize verification of a transaction based on a spending category associated with the transaction data. For example, verification system may receive transaction data for two different transactions. One of the transactions may be associated with payment for medical expenses (reflected in a spending category), and another may be associated with payment for dental care (reflected in a spending category). Verification system may retrieve the total authorized spending amount for the current calendar year and determine whether adding the transaction amount for the two additional transactions exceeds the spending limit.

In one example, the spending limit for the account is $6000 for the calendar year. The total authorized spending amount for the calendar year is $5,500. The verification system receives transaction data for two additional transactions (1) $300 payment for a visit to a doctor's office, and (2) $200 payment for an electric toothbrush. The transaction data for the first transaction may include a spending category indicating this is for a medical expense. The transaction data for the second transaction may include a spending category indicating it is for a dental expense. In this example, verification system will determine that adding the $300 and $200 transaction amounts to the current total authorized spending amount for the calendar year ($5,500) equals $6,200, which exceeds the total spending limit of $6000 for this account. Verification system may then proceed to attempt to verify the $300 payment for the doctor's visit, while declining to verify the $200 payment for the electric toothbrush. This prioritization may be based on priority flags set by the user of the verification system.

It will be appreciated that the above-discussed examples and corresponding descriptions are merely exemplary, and that the invention is not limited to these exemplary embodiments only.

It will further be appreciated that the execution of the various machine-implemented processes and steps described herein may occur via the computerized execution of processor-executable instructions stored on a non-transitory computer-readable medium, e.g., random access memory (RAM), read-only memory (ROM), programmable read-only memory (PROM), volatile, nonvolatile, or other electronic memory mechanism. Thus, for example, the operations described herein as being performed by computing devices and/or components thereof may be carried out by according to processor-executable instructions and/or installed applications corresponding to software, firmware, and/or computer hardware. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. Methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. As used herein, the term “component” is intended to be broadly construed as hardware, firmware, or a combination of hardware and software.

It will be appreciated that the embodiments of the invention described herein are merely exemplary. Variations of these embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The functionality of embodiments of this invention does not otherwise exist within the industry of tax-free healthcare accounts. The inventors believe that embodiments of this invention will help to revolutionize the substantiation experience for accountholders and their employers/plan sponsors. The invention is intended to alleviate accountholder frustration and pain points, while adding value to the TPA's ability to achieve higher auto-substantiation rates.

What is claimed is:

1. A transaction verification system, comprising one or more processors and one or more non-transitory computer-readable mediums having processor-executable instructions stored thereon, wherein the processor-executable instructions, when executed by the one or more processors, facilitate:
receiving transaction data corresponding to a transaction between an account holder and a merchant, wherein the transaction data includes a transaction amount and identifying information for a payment account of the account holder;
determining whether the merchant associated with the transaction data has been previously verified;
comparing a spending limit associated with the payment account with the transaction amount; and
updating a record associated with the transaction data to indicate whether further verification is needed.

2. The system according to claim 1, wherein comparing a spending limit associated with the payment account with the transaction amount comprises retrieving a total amount of authorized spending associated with the payment account, adding the transaction amount to the total amount of authorized spending to compute a pending total, and comparing the pending total to the spending limit associated with the payment account.

3. The system according to claim 2, wherein if the pending total exceeds the spending limit, updating the record associated with the transaction data to indicate that no further verification is needed.

4. The system of claim 1, wherein the one or more processors and one or more non-transitory computer-readable mediums having processor-executable instructions stored thereon, wherein the processor-executable instructions, when executed by the one or more processors, also facilitate:
retrieving copay data associated with the account holder;
comparing the copay data with the transaction data; and
updating the record associated with the transaction data to indicate no further verification is needed if the copay data is within a certain threshold amount of the transaction data.

5. The system of claim 1, wherein the one or more processors and one or more non-transitory computer-readable mediums having processor-executable instructions stored thereon, wherein the processor-executable instructions, when executed by the one or more processors, also facilitate:
retrieving payment history data associated with the payment account;
comparing the payment history data with the transaction data; and
updating the record associated with the transaction data to indicate no further verification is needed if the payment history data is within a certain threshold amount of the transaction data.

6. The system according to claim 1, wherein the payment account is one of a Flexible Spending Account (FSA) or a Health Reimbursement Account (HRA).

7. The system according to claim 1, wherein the one or more processors and one or more non-transitory computer-readable mediums having processor-executable instructions stored thereon, wherein the processor-executable instructions, when executed by the one or more processors, also facilitate:
retrieving a total amount of authorized spending associated with the payment account;
identifying at least one regular payment from the total amount of authorized spending;
calculating a projected spending total based on the at least one regular payment and the total amount of authorized spending;
comparing the projected spending total with the spending limit; and
if the projected spending total exceeds the spending limit, updating the record associated with the transaction data to indicate that no further verification is needed.

8. A transaction verification method, comprising:
receiving transaction data corresponding to a transaction between an account holder and a merchant, wherein the transaction data includes a transaction amount and identifying information for a payment account of the account holder;
determining whether the merchant associated with the transaction data has been previously verified;
comparing a spending limit associated with the payment account with the transaction amount; and
updating a record associated with the transaction data to indicate whether further verification is needed.

9. The method according to claim 8, wherein comparing a spending limit associated with the payment account with the transaction amount comprises retrieving a total amount of authorized spending associated with the payment account, adding the transaction amount to the total amount of authorized spending to compute a pending total, and comparing the pending total to the spending limit associated with the payment account.

10. The method of claim 9, wherein if the pending total exceeds the spending limit, updating the record associated with the transaction data to indicate that no further verification is needed.

11. The method of claim 8, further comprising retrieving copay data associated with the account holder, comparing the copay data with the transaction data, and updating the record associated with the transaction data to indicate no further verification is needed if the copay data is within a certain threshold amount of the transaction data.

12. The method of claim 8, further comprising retrieving payment history data associated with the payment account, comparing the payment history data with the transaction data, and updating the record associated with the transaction data to indicate no further verification is needed if the payment history data is within a certain threshold amount of the transaction data.

13. The method of claim 8, wherein the payment account is one of a Flexible Spending Account (FSA) or a Health Reimbursement Account (HRA).

14. The method of claim 8, further comprising:
retrieving a total amount of authorized spending associated with the payment account;
identifying at least one regular payment from the total amount of authorized spending;
calculating a projected spending total based on the at least one regular payment and the total amount of authorized spending;
comparing the projected spending total with the spending limit; and
if the projected spending total exceeds the spending limit, updating the record associated with the transaction data to indicate that no further verification is needed.
